(19) United States
(12) Patent Application Publication
(10) Pub. No.: US 2002/0077452 A1
(43) Pub. Date: Jun. 20, 2002

(54) Sieve filtration of filled polyols with dynamic pressure disc filters

(76) Inventors: Arne Braun, Leverkusen (DE); Michael Brockelt, Leverkusen, (DE); Manfred Dietrich, Frankfurt (DE); Hans-Jurgen Klocke, Duisburg (DE); Matthias Wohak, West Chester, PA (US); Uwe Klingler, New Martinsville, WV (US)

Correspondence Address: BAYER CORPORATION, PATENT DEPARTMENT, 100 BAYER ROAD, PITTSBURGH, PA, 15205, US

(21) Appl. No.: 10/023,173

(22) Filed: Dec. 17, 2001

(30) Foreign Application Priority Data
Dec. 20, 2000 (DE) 10063484.2

(51) Int. Cl. C08G 2/00

(52) U.S. Cl. 528/480

(57) ABSTRACT

The present invention provides an improved process for the continuous filtration of filled polyols containing deformable solid particles, wherein filtration of the filled polyols is performed with dynamic pressure disc filters. This process requires that:

a) filtration occur at a filtration pressure difference of≦0.5 bar,

b) back-flushing is performed at a back-flush pressure difference of≧0.5 bar, measured during back-flushing in the stationary state, and

c) back-flushing is performed (at the latest) when the filtrate throughput of a module has fallen by 65%, in comparison to the throughput of the module when the filter medium is not partially clogged with solids, under otherwise identical conditions.

This improved process provides a long operating life and a high throughput.

### BACKGROUND OF THE INVENTION

The present invention relates to a process for the sieve filtration of filled polyols with dynamic pressure disc filters.

The term sieve filtration refers here to the selective separation of coarse-particle material from a suspension or dispersion using a sieve or filter medium. Dynamic cross flow filters can offer advantages over other technologies for this type of task. Dynamic cross flow filters having a radial gap, disc-shaped filter elements and utilizing pressure as the driving force for filtration or sieve filtration, are also known as dynamic pressure disc filters.

Dynamic cross flow filters are closed, continuously operating units that utilize the principle of dynamic filtration. In the dynamic filtration process, shear forces are established vertically to the direction of filtration by means of a tangential flow across the filter medium, as a consequence of which the particles retained by the filter medium are redispersed into the core flow. The stationary tubular modules across which the flow is driven by an external pump circuit and which are used for instance for microfiltration and nanofiltration stand in contrast to the dynamic cross flow filters, in which the filter medium and/or additional components such as stirring elements are actuated in a closed vessel by a mechanical drive in order to develop the shear gradient.

Dynamic cross flow filter units have been known for decades. One of the first descriptions of the principle behind this equipment can be found in a Czech patent dating from 1969 (see CZ-AS-1 288 563). Dynamic cross flow filters exist in a number of different design forms. They can be divided by way of example into units having an axial or a radial gap.

Representatives of the first variant include the Escher-Wyss pressure filter, in which, coaxially to a rotating internal filter cylinder, a stationary external filter cylinder forms the annular gap in which dynamic filtration takes place, or the coaxial gap filter by Netzsch. In some versions of the radial gap shear filters, radial gaps of a defined gap width are formed by an alternating arrangement of rotating stirring elements and stationary disc-shaped filter elements. A feature of such filter units is that in order to increase the filtering surface, several of these elements can be sandwiched together in series to form a closed, pressure-tight unit. The sealing towards the environment is usually facilitated by the stationary filter discs, which form interior filter chambers in which the rotating element (rotor) turns. In recent decades, various versions of such dynamic cross flow filters with radial gap, disc-shaped filter elements and pressure as driving force, in other words dynamic pressure disc filters, have been commercially available.

Dynamic pressure disc filters with filtration at the stationary elements are characterised by the alternating arrangement of moving stirring elements and stationary disc-shaped filter modules. Pairs of stators form a chamber in which a stirring element (rotor) is located. The rotation of the stirring elements close to the filter disc, which is equipped with filter media, e.g. sieves, moves the suspension in a transverse flow perpendicular to the filter medium. This produces a marked velocity gradient in the vicinity of the filtering surface. A high shear stress develops, causing the coarse particles arriving at the filter medium to be dragged back into the core flow of the suspension. This largely prevents the filter media from becoming clogged with the oversize particles which are to be held back. At the same time the coarse particles should be separated out entirely. The purefied mother liquor, optionally with the desired fine-particle fraction, passes unhindered through the filter medium. The suspension accumulates more and more coarse particles as it moves from one chamber to the next and is extracted from the final chamber as a retentate using a valve or a gear pump, for example.

A feature of dynamic pressure disc filters is that the rotational speed of the stirring element, or the flow velocity above the filter medium, and the filtration pressure difference can be adjusted independently of one another. In this way, the forces acting on the particles can be shifted during operation either in favor of redispersal into the core flow or towards deposit on the filter medium. Thus, in addition to setting a favorable combination of pressure level and stirrer speed, the filtration pressure difference can be removed at times, e.g. by a periodic, short-term interruption of filtrate flow (closing of filtrate valves). Under the continuous stirring action, the filter media partially coated with particles are rinsed clean. Depending on the application, this measure, which is also referred to below as zero pressure cleaning, can prevent, or at least delay, blocking of the filter media. Thus, the net filtrate flow increases.

A further possibility for detaching the coating or removing particles remaining at the filter medium, which is commonly known from microfiltration with membranes, involves briefly back-flushing the filter media from the filtrate side, and hence against the direction of filtration, with filtrate or with another particle-free fluid.

Filled polyols are viscous suspensions/dispersions consisting of fine-particle solids in polyols. They are also known as, for example, filler-containing polyols, polymer polyols and/or graft copolymers. Examples of solids used include, for example, styrene-acrylonitrile polymers and polyureas (both polymer polyols) or melamine. As a consequence of the process conditions, the particle spectrum exhibits undesirable coarser particles in addition to the desirable fine-particle fraction. These are both dimensionally variable particles and dimensionally stable, needle-shaped and in some cases also compact particles. The undesirable oversize particles predominantly occur in particle sizes in the range from approx. 20 to 500 μm. These coarse fractions lead to increased blocking of foaming plants during processing to polyurethanes. For example, the uniform flow characteristics over an extended period (continuous foaming) that are required for use of the NovaFlex® technology are not achieved. This separation task cannot be satisfactorily managed with conventional separating devices, e.g. bag filters, cartridge filters, back-flush filters or screening machines, since units of this type rapidly become blocked and are therefore, labor-intensive.

JP-A-06199929 describes the mechanical grinding of coarse particles that are formed during the production of polymer polyol and trapped by a 100 to 700 mesh screen, to sizes<4 μm with the aid of a grinding machine. Complete comminution of the coarse particles cannot be guaranteed using a comminution process, however, nor can deformable particles be reliably crushed.

WO-93/24211 describes the cross-flow filtration of solid impurities (from 1 μm to>200 μm) from polymer dispersions using non-metallic, inorganic filter materials (e.g. ceramics) with pore sizes of 0.5 to 10 μm, at flow rates of 1 to 3 m/s, and with periodic back-flushing of the modules. In the working examples, for instance, WO-93/24211 discloses a filtration at approx. 1.4 bar differential pressure, in which back-flushing is performed every 3 to 5 minutes at a differential pressure of approx. 5.5 bar. Retention of dimensionally variable particles cannot be guaranteed in the cited process because of the high pressure differences during filtration. Moreover, the process must be able to cope with a large amount of retentate, or a multi-stage process must be chosen in order to minimise the amount of retentate.

Furthermore, application of the processes described in accordance with the prior art commonly leads to blocking of the filter media and to a poor separating effect.

The disadvantage of the processes for filtering filled polyols containing stable and deformable particles as described in the prior art is that a selective, almost complete separation of coarse particles with free passage of the finer filler particles is either impossible to achieve, or it can be achieved only with considerable labor costs because of the rapid blocking of the filter media.

### SUMMARY OF THE INVENTION

The object of the present invention therefore consists in providing a continuous process for the sieve filtration of filled polyols containing deformable particles, wherein the process has a long operating life and high throughput.

The invention provides a process for the continuous filtration of filled polyols containing deformable, solid particles. This process comprises filtering of filled polyols with dynamic pressure disc filters; wherein:

a) the filtration pressure difference across the filter media is<0.5 bar;

b) back-flushing is performed at a back-flush pressure difference of≧0.5 bar, as measured during back-flushing in the stationary state, and

c) back-flushing is performed no later than the point at which the filtrate throughput of a module has fallen by 65% in comparison to the filtrate throughput of the module when the filter medium is not partially clogged with solids, under otherwise identical conditions.

The principle of dynamic cross-flow filtration with integral back-flush capability as used in the dynamic pressure disc filter prevents the filtering surfaces from becoming blocked with the coarse fraction which are separated from the filtrate stream. Thus, the presently claimed process provides a continuous operation that, in comparison with alternative processes, is capable of automation, and is not associated with high labor costs.

In accordance with the present invention, the process is performed at a filtration pressure difference across the filter media of from 0.01 to 0.5 bar, preferably from 0.05 to 0.4 bar, and most preferably from 0.05 to 0.2 bar. The coarse particle fraction to be separated in the classification step may contain hard, needle-shaped or compact particles, in addition to soft, deformable particles. A moderate filtration pressure difference is critical for the filtration of polymer polyols (i.e. filled polyols) in order to limit the penetration or incorporation of these particles into the sieve openings of the filter media, particularly at elevated temperatures.

Back-flushing of the filter media is performed in accordance with the present invention at pressure differences of≧0.5 bar, preferably of 0.6 to 5 bar, and most preferably of 1.0 to 2.0 bar, that prevail during back-flushing in the stationary state. The upper limit for the back-flush pressure difference is determined by the pressure resistance of the dynamic pressure disc filter and the mechanical stability of the filter media, and is conventionally around 2 to 6 bar. In the case of more sophisticated designs, the upper limit can be up to about 16 bar.

Back-flushing is initiated by opening a back-flush valve. The initial pressure of the back-flush liquid falls partially once the back-flush valve has been opened, and causes the liquid to flow through the filter medium in the back-flush direction. In the course of this process, the particles deposited on the filter medium during filtration are detached and the filter medium is cleaned. Once the filter medium has been successfully cleaned, a stationary flow state is established through the filter medium because the pressure drop across the filter medium stops changing.

The back-flush pressure difference in the stationary state refers to the prevailing pressure difference between the chambers directly in front of and directly behind the filter medium caused by the flow through the filter medium that has already been cleaned.

The aim of back-flushing is to suppress the inevitable, gradual clogging caused by particles adhering to the filter media or even the incorporation of particles into the filter media (i.e. clogging particles) which occurs during sieve filtration of filled polyols, despite the cleaning action of the stirrers and zero pressure cleaning, and to regenerate the filter media completely. Since back-flushing requires filtrate, which then has to be filtered again, the amount of back-flush liquid should be kept as small as possible. For optimum overall throughput, a balanced combination of back-flushing and zero pressure cleaning must be achieved by skillful adjustment of frequency, sequence and duration. The optimum adjustment can easily be determined by means of tests.

For the back-flushing process, the highest possible back-flush pressure is chosen and the back-flush time is kept short. The back-flush time is preferably from 0.5 to 60 s, more preferably from 0.5 to 5 s, and most preferably from 1 to 3 s. The amount of back-flushed liquid should be sufficient to entrain coarse particles from the actively separating layer of filter medium into the active shear zone of the core flow. Longer back-flush times over and above those described above merely increase consumption. The maximum back-flush pressure that can be achieved in a particular machine is limited by the mechanical stability of the filter media used and the way in which they are attached to the filter module.

Back-flushing is performed according to the invention no later than the point at which the throughput of a module has fallen by 65%, preferably 30%, and most preferably 15%, in comparison to the throughput of the module when the filter medium is free of clogging with solids, under otherwise identical conditions.

The overall throughput falls if the filter media become too clogged. It can also happen that the particles become so mechanically bonded with the sieve that the filter can no longer be freed from the stable or deformable particles by back-flushing. In the absence of back-flushing during filtration of filled polyols on dynamic pressure disc filers, a process similar to ideal pore plugging filtration occurs during the filtration process. As the filtration time increases, resistance of the filter media rises exponentially. If back-flushing is performed sufficiently frequently such that the throughput of a module under identical operating settings falls by a maximum of 65% of the filtrate flow rate through unclogged filter media, the accelerated blocking of the module concerned is avoided. The last modules on the retentate side are particularly at risk, since the concentration of coarse particles on the suspension side is at its highest here. In addition to shifting the concentration profile in the filter towards the feed side, which reduces the throughput and increases the rate of blocking of those modules, back-flushing of the module concerned becomes increasingly difficult, since ultra-fine particles can accumulate over time in the spaces between pores that are partially blocked with coarse particles, causing the particles to bond more strongly to the filter medium. This rapidly increases the danger of a clogging of the filter media that cannot be reversed by back-flushing. When this occurs, the filter has to be stopped, cooled down, and started up again from the cold state in order to regenerate the filter media. Obviously, during this time the filter cannot be used for filtration. Such a shut-down takes at least 4 hours in industrial units. If this type of regeneration is unsuccessful, however, the filter has to be drained, disassembled and cleaned manually, which generally results in a production downtime of several days.

Filtrate removal and back-flushing is preferably controlled separately for each filter module. If a dynamic pressure disc filter with several filter modules connected in series on the retentate side is used for the sieve filtration of filled polyols, a continuous, permanently non-clogging filtration operation can be achieved which is particularly effective by appropriately adjusting and combining the cleaning action of the stirrer during removal of the filtration pressure difference (zero pressure cleaning) with regular back-flushing of the filter media if the filtering surfaces are also divided into the smallest possible units and each of these units is controlled separately and automatically at a suitable cycle rate.

In a preferred embodiment, sintered, multi-layer metal fabrics having square or rectangular meshes are used as filter materials for sieve filtration with dynamic pressure disc filters. Due to the narrow pore size distribution and the absence of depth effect characteristic of these fabrics, these filter media are less susceptible to blocking and permit a clean separation.

The temperature level during filtration in dynamic pressure disc filters is determined by feed temperature and feed flow rate, the stirring power dissipated by the stirring elements, the effluent flow rates of filtrate and retentate, and the transfer of heat from the filter housing to the environment. If back-flushing is performed with comparatively cold filtrate or with a supply of cold washing or dilution liquid, an additional cooling effect occurs.

A substantial energy input from the stirrer is needed to generate an adequate shear stress for filtration. In the stationary operating state the temperature in the chambers therefore increases from the feed side to the retentate side.

As the temperature rises, the product viscosity falls. Under otherwise identical conditions (pressure difference, stirrer speed), the specific filtrate throughput, which is inversely proportional to the viscosity, rises, the stirrer power input drops and the shear stress at the filter cloth falls.

An elevated entrainment force with the filtrate stream and reduced shear stress signify a higher probability of coarse particles being deposited at the screen or faster screen clogging. This explains the effect that has been found of improved screen regeneration at lower temperatures.

At the same time the separating capacity deteriorates when dimensionally variable particles become softer at elevated temperature, and then work their way through the filter medium more quickly.

In order to comply with the permissible temperature range for a particular product, additional cooling may be necessary. To this end, the jacket of the filter modules can be cooled by means of cooling channels, for example.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Example 1

(According to the Invention)

Sieve filtration of a styrene-acrylonitrile (SAN)-filled polyol having a solids content of 40% by weight, and approx. 20-40 ppm coarse particle fraction in the feed stream was conducted with a 12 m² dynamic pressure disc filter with 12 modules.

The coarse particle fraction consisted of needle-shaped specks measuring 20-500 μm in length. 1.5 t/h polymer polyol were filtered at a stirrer speed of 115 rpm and a pressure difference of approx. 0.1 bar, using sintered metal screens having 20 μm square mesh fabric in the uppermost, actively separating fabric layer as filter media. The feed temperature was 65° C.

The prevailing temperature in the final module was approx. 80° C. with cooling of the module jacket. The proportion of retenate flow rate to feed flow rate was 1%. The retentate concentration was measured to be almost 4,000 ppm. At intervals in the order of one minute, the filtration pressure difference in the modules was lifted for approx. 10 s in accordance with an automatic cycle plan (zero pressure cleaning). The modules were actuated individually. Around 10 modules were always active whilst 2 modules were being cleaned. Fluctuations in throughput due to differences in the filtration capacity of the modules were negligible. Individual throttling of the filtrate lines was done such that the flow of filtrate out of the modules was roughly uniform, compensating for the temperature influence on the viscosity. In addition, the modules were individually back-flushed with filtrate in sequence for a few seconds every 6 minutes at approx. 1.4 bar pressure difference. The amount of filtrate required for back-flushing was around 15% of the net throughput.

During back-flushing the pressure on the suspension side rose by 0.1 to 0.15 bar. This additional pressure largely dissipated in the waiting period before back-flushing of the next module.

A permanently non-clogging operation of the filtration screens was obtained with the chosen combination. The coarse particle fraction was reduced by a factor>>100, to values of well below 1 ppm.

### Example 2

This series of examples illustrates that too low of a back-flow pressure difference causes the filter media to become blocked.

### Example 2a

Comparative Example

Sieve filtration of a SAN-filled polyol was conducted on a dynamic pressure disc filter having a filtering surface of 1.25 m² on 5 filter modules with 25 μm screens at 0.1 bar filtration pressure difference, a stirrer speed of 190 rpm and a filtration temperature of 80° C. Back-flushing was performed in the stationary state at a maximum differential pressure of 0.2 bar across the filter media. Within a few hours, the filter media had become so clogged that the total throughput had fallen by approx. 50%. The clogged filter media could no longer be regenerated during operation, even with increased back-flushing frequency. Continuous operation was not possible at the selected back-flushing pressure.

### Example 2b

According to the Invention

A permanently non-blocking operation was achieved using the same filled polyol, equipment and parameters as described above in Example 2a by converting the filter to a higher back-flush pressure difference of 0.65 bar in the stationary state.

### Example 3

This series of examples illustrates that an insufficient frequency of back-flushing causes the throughput to drop.

### Example 3a

Comparative example

Sieve filtration of an HS 100® SAN-filled polyol from Bayer Corporation with a higher proportion of deformable coarse particles than in Examples 1 and 2 was conducted on a dynamic pressure disc filter having a filtering surface of 1.25 m² on 5 filter modules with 20 μm screens at 0.1 bar filtration pressure difference, a stirrer speed of 214 rpm and a filtration temperature of 87° C. The modules were back-flushed groupwise at a differential pressure of approx. 0.65 bar across the filter media in the stationary state. The back-flushing interval was set to 300 s.

Despite the back-flushing, after an operating period of approx. 2 h at an almost constant throughput of approx. 165 kg/h, the filter media clogged over the next 3 h to such an extent that the filtrate throughput fell to approx. 70 kg/h. The filter media in some modules were more heavily clogged than others, such that the throughput at these filter modules had fallen by more than 70%.

The filter media were only able to be regenerated after stopping the filter, cooling it and then starting it again. This cumbersome regeneration process took around 4 hours. Due to the good cleaning action of the stirrer when the product was cold, the filter media regenerated almost completely in the experiment under consideration.

### Example 3b

According to the invention

The same filled polyol, equipment and parameters were used in Example 3b as in Example 3a, with the exception of the back-flushing interval which was then adjusted to 120 s. This back-flushing interval allowed the throughput to be maintained at a permanently high level. Over the next 16 h of operating time, an average throughput of 130 kg/h was achieved, corresponding to approx. 80% of the throughput that was possible when the machine was started up with unclogged filter media. Even after 16 hours, there was no need for a time-consuming regeneration by stopping the filter, cooling it and starting it again.

### Example 4

This series of examples illustrates that elevated filtration pressure of>0.5 bar results in severe clogging of the filter media.

### Example 4a

Comparative example

Filtration of a SAN-filled polyol was conducted on a dynamic pressure disc filter with 5 modules. Zero pressure cleaning was set for 10 s periods after 30 s filtration. Initially, the filter media were not back-flushed. The filtration pressure difference was 0.55 bar. The filter media clogged continuously during operation. After 1 h, the amount of filtrate was only 5% of the initial value with unclogged filter media. After a further 30 min, the screens were completely blocked. In other words, there was negligible filtrate flow. Cleaning of the blocked filter media was a very cumbersome process. The proportion of quality-reducing coarse particles in the filtrate was considerably higher than that achieved with filtration at a lower pressure difference.

### Example 4b

According to the invention

The same product as in Example 4a was processed as in Example 4a, with the exception being that a lower pressure difference was used. As in Example 4a, no back-flushing was used in Example 4b. The filtration pressure difference across the filter media was only approx. 0.1 bar in this case; and the other settings remained unchanged. With a lower initial filtration capacity in comparison to the experiment at a higher pressure difference (i.e. Example 4a), 95% of the throughput obtained with unclogged filter media was retained after 6 h despite a gradual clogging of the filter media. Subsequent cleaning of the filter media by back-flushing at a back-flush pressure difference of>0.5 bar resulted in the complete regeneration of the filter media.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the continuous filtration of filled polyols containing deformable, solid particles, comprising filtering of filled polyols with dynamic pressure disc filters, wherein:
a) the filtration pressure difference across the filter media is≦0.5 bar,
b) back-flushing is performed at a back-flush pressure difference of≧0.5 bar, as measured during back-flushing in the stationary state, and
c) back-flushing is performed no later than the point at which the filtrate throughput of a module has fallen by 65% in comparison with the filtrate throughput at the module when the filter medium is not partially clogged with solids, under otherwise identical conditions.

2. The process of claim 1, wherein a) said filtration pressure difference is from 0.01 to 0.5 bar.

3. The process of claim 2, wherein a) said filtration pressure difference is from 0.05 to 0.4 bar.

4. The process of claim 2, wherein a) said filtration pressure difference is from 0.05 to 0.2 bar.

5. The process of claim 1, wherein b) said back-flushing is performed at pressure differences of from 0.6 to 5 bar.

6. The process of claim 5, wherein b) said back-flushing is performed at pressure differences of from 1.0 to 2.0 bar.

7. The process of claim 1, wherein c) said back-flushing is performed when the throughput of a module has fallen by no more than 30%.

8. The process of claim 7, wherein c) said back-flushing is performed when the throughput of a module has fallen by no more than 15%.

9. The process of claim 1, wherein b) said back-flushing occurs for 0.5 to 60 seconds.
